(19) United States
(12) Patent Application Publication
(10) Pub. No.: US 2010/0161643 A1
(43) Pub. Date: Jun. 24, 2010

(54) SEGMENTATION OF INTERLEAVED QUERY MISSIONS INTO QUERY CHAINS

(75) Inventors: Aristides Gionis, Barcelona (ES); Debora Donato, Barcelona (ES); Francesco Bonchi, Barcelona (ES); Paolo Boldi, Milano (IT); Sebastiano Vigna, Milano (IT)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/344,138

(22) Filed: Dec. 24, 2008

(51) Int. Cl. G06F 7/06; G06F 17/30

(52) U.S. Cl. 707/765; 707/E17.014

(57) ABSTRACT

The subject matter disclosed herein relates to segmentation of interleaved query missions into a plurality of query chains.

### BACKGROUND

1. Field

The subject matter disclosed herein relates to data processing, and more particularly to methods and apparatuses that may be implemented to segment interleaved query missions into separated query chains through one or more computing platforms and/or other like devices.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided, which allow for the copious amounts of information to be searched through in an efficient manner. For example, service providers may allow for users to search the World Wide Web or other like networks using search engines. Similar tools or services may allow for one or more databases or other like data repositories to be searched. With so much information being available, there is a continuing need for methods and systems that allow for pertinent information to be analyzed in an efficient manner.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a chart illustrating a distribution of frequency of query pairs in accordance with one or more exemplary embodiments.

FIG. 2 is a diagram illustrating a query flow graph in accordance with one or more exemplary embodiments.

FIG. 3 is a process for segmentation of individual query sessions in accordance with one or more exemplary embodiments.

FIG. 4 is a process for forming a query flow graph in accordance with one or more exemplary embodiments.

FIG. 5 is a process for segmentation of individual query sessions in accordance with one or more exemplary embodiments.

FIG. 6 is a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, process, components and/or circuits have not been described in detail.

Query logs may be utilized to record the actions of users of search engines. For example, a query log may record information about the search actions of the users of a search engine. Such information may include queries submitted by the users, documents viewed as a result to individual queries, and documents clicked by the users. Such query logs be used to extract useful information regarding interests, preferences, and/or behavior of such users. Additionally or alternatively, such query logs may be utilized to provide implicit feedback regarding search engine results. Mining of information available in such query logs may be used in several applications, including query log analysis, user profiling, user personalization, advertising, query recommendation, and more.

The volume of information recorded daily in query logs contains a wealth of valuable knowledge about how web users interact with search engines as well as information about the interests and the preferences of those users. Extracting behavioral patterns from this wealth of information may be utilized to improve the service provided by search engines and/or to develop alternative web search paradigms. Unfortunately, mining query logs may pose technical challenges that may arise due to the volume of data, poorly formulated queries, ambiguity, and/or sparsity, among others.

A sequence of all the queries of a user in the query log, ordered by timestamp, may be referred to as a supersession. Thus, a supersession may be divided into a sequence of sessions in which consecutive sessions have time differences larger than a timeout threshold. Accordingly, query logs may be divided into one or more sessions. A “query session” or “session,” as used herein may refer to a sequence of queries of one particular user. In some instances, such a session may be associated with a specific time limit. In such an instance, given a query log, a corresponding set of sessions may be constructed by sorting all queries recorded in the query log first by a user ID, and then by a timestamp, and by performing one additional pass to split sessions of the same user whenever the time difference of two queries exceeds a timeout threshold.

Such sessions may contain one or more chains. As used herein the term “chain” may refer to a topically coherent sequence of queries of one user. For example, a chain may include a sequence of queries with a similar information need or similar mission. For instance, a query chain may contain the following sequence of queries: “brake pads”; “auto repair”; “auto body shop”; “batteries”; “car batteries”; “buy car battery online”; and/or the like. The concept of a chain may also be referred to as a “mission” and/or “logical session”.

Unlike the concept of session, chains may involve relating queries based on the user information need or mission. Accordingly, chains may not require the imposition of a timeout constraint. As an example, queries of a user that is interested in planning a trip may include searches for tickets, hotels, and/or other tourist information over a period of several weeks may be grouped in the same chain, while these same queries might be divided into several sessions based on a timeout constraint.

Additionally, for queries composing a given chain may not be consecutive. In such a case, a user may temporally alternate between two or more information needs or missions. Such a temporal alternation and/or other like switching between two or more information needs or missions may be referred to herein as “interleaved query missions.” Accordingly, in cases where there are interleaved query missions, there may be two or more chains. Following the previous example, a user that is planning a trip may search for tickets in one day, then make some other queries related to a newly released movie, and then return to trip planning the next day by searching for a hotel. Thus, a given session may contain queries from many chains, and inversely, a chain may contain queries from many sessions.

As will be described in greater detail below, methods and apparatuses may be implemented to segment interleaved query missions into separated query chains. During such segmentation, a chain associated with a given mission may be separated from two or more interleaved query missions. Such a segmentation of interleaved query missions may be utilized to model the behavior of users that have a number of information needs or missions and submit queries related to such information needs or missions, but in an interleaved fashion. Such a segmentation may address interleaved query missions starting from a session that may be defined without a timeout limit on such a session. Such a session without a timeout limit may include an entire query history of a user (such as a supersession, for example) or may be a subset of such a supersession.

Such a segmentation of interleaved query missions may utilize a query flow graph and/or the like. Such a query flow graph may include a graph representation of interesting knowledge about latent querying behavior. As used herein the term “query flow graph” refers to a representation of the information contained in a query log capable of facilitating analysis of user behavior contained in a query log.

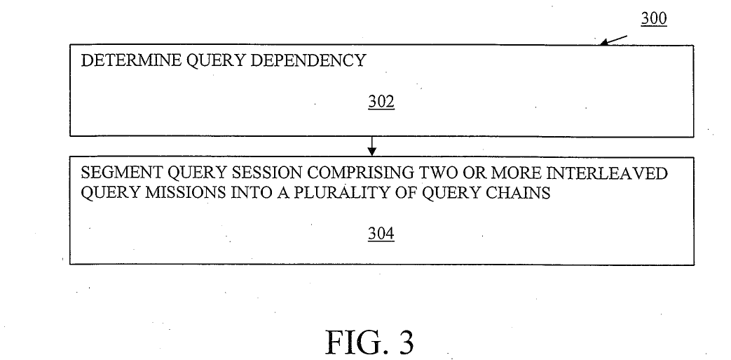

FIG. 3 is an illustrative flow diagram of a process 300 which may be utilized for segmentation of individual query sessions in accordance with some example embodiments. Additionally, although process 300, as shown in FIG. 3, comprises one particular order of actions, the order in which the actions are presented does not necessarily limit claimed subject matter to any particular order. Likewise, intervening actions not shown in FIG. 3 and/or additional actions not shown in FIG. 3 may be employed and/or some of the actions shown in FIG. 3 may be eliminated, without departing from the scope of claimed subject matter. Process 300 depicted in FIG. 3 may in alternative embodiments be implemented in software, hardware, and/or firmware, and may comprise discrete operations.

As illustrated, process 300 may be implemented to segment interleaved query missions into separated query chains. During such segmentation, a chain associated with a given mission may be separated from two or more interleaved query missions. Such a segmentation of interleaved query missions may be utilized to model the behavior of users that have a number of information needs or missions and submit queries related to such information needs or missions, but in an interleaved fashion.

At block 302, at least one query dependency may be determined. For example, such query dependencies may be determined based at least in part on a temporal order of queries. As used herein the term “temporal order” may refer to a time-wise sequence among two or more queries. For example, such a temporal order may be established based at least in part on a timestamp associated with individual queries. Additionally or alternatively, such query dependencies may be determined based at least in part on a quantification of similarity between individual queries. As used herein the term “quantification of similarity” may refer to a measure of probability that two queries are part of the same search mission. Such a determination of query dependencies may include formation of a query flow graph, as is described in greater detail below.

At block 304, at least one query session may be segmented. For example, such query sessions may included two or more interleaved query missions. Such interleaved query missions may be segmented into a plurality of query chains. For example, such interleaved query missions may be segmented into separated query chains based at least in part on such determined query dependencies, as discussed above with respect to block 302. Such segmentation may address interleaved query missions starting from a session that may be defined without a timeout limit on such a session. Such a session without a timeout limit may include an entire query history of users (such as a supersession, for example) or may be a subset of such a supersession. Accordingly, segmenting individual query sessions may be performed without a timeout limit on an individual query session.

In one example, a query log may record information about search actions of users of a search engine. Such information may include the queries submitted by the users, documents viewed as a result to each query, and documents clicked by the users. A typical query log [symbol] is a set of records <qᵢ, uᵢ, tᵢ, Vᵢ, Cᵢ>, where: qᵢ is the submitted query, uᵢ is an anonymized identifier for the user that submitted the query, tᵢ is a timestamp, Vᵢ is the set of documents returned as results to the query, and Cᵢ is the set of documents clicked by the user. In the above representation, it may be assumed that if U is the set of users to the search engine and D is the set of documents indexed by the search engine, then uᵢεU and Cᵢ⊂Vᵢ⊂D. Information from the results of the queries (Cᵢ and Vᵢ)—may not be utilized in some embodiments discussed herein. In such cases, query logs may be denoted by [symbol] ={<qᵢ, uᵢ, tᵢ>}.

A query session, or session, may be defined as the sequence of queries of one particular user. Such a session may be defined within a specific time limit. More formally, if t_{Θ} is a timeout threshold, a user query session S may be defined a maximal ordered sequence

S= [symbol] [symbol] qᵢ_{₁},uᵢ_{₁},tᵢ_{₁} [symbol] , . . . , [symbol] qᵢ_{ₖ},uᵢ_{ₖ},tᵢ_{ₖ} [symbol] [symbol] , where

uᵢ_{₁}= . . . =uᵢ_{ₖ}=uε [symbol] ,
tᵢ_{₁}≦ . . . ≦tᵢ_{ₖ}, and
tᵢ_{ⱼ₊₁}−tᵢ_{ⱼ}≦t_{θ},
for all j=1, 2, . . . , k−1. Given a query log [symbol] , a corresponding set of sessions may be constructed by sorting all records of the query log first by user ID uᵢ, and then by timestamp tᵢ, and by performing one additional pass to split sessions of the same user. For example, such a split of sessions of the same user may be done in cases where a time difference of two queries exceeds a timeout threshold. Such a timeout threshold for splitting sessions may be set t_{Θ}=30 minutes, and/or the like. Alternatively, as discussed above, segmentation may address interleaved query missions starting from a session that may be defined without a timeout limit on such a session. Such a session without a timeout limit may include an entire query history of users (such as a supersession, for example) or may be a subset of such a supersession. Accordingly, segmenting individual query sessions may be performed without a timeout limit on an individual query session.

As will be discussed below in greater detail, a chain may be separated from a query session without the imposition of a timeout constraint. Therefore, as an example, queries of a given user that is interested in planning a trip and searches for tickets, hotels, and other tourist information over a period of several weeks may be grouped in the same chain without the imposition of a timeout constraint. Additionally, for the queries composing a given chain, such queries do not necessarily need to be consecutive. Following the previous example, a given user that is planning a trip may search for tickets in one day, then make some other queries related to a newly released movie, and then return to trip planning the next day by searching for a hotel. Thus, a session may contain queries from many chains, and inversely, a chain may contain queries from many sessions.

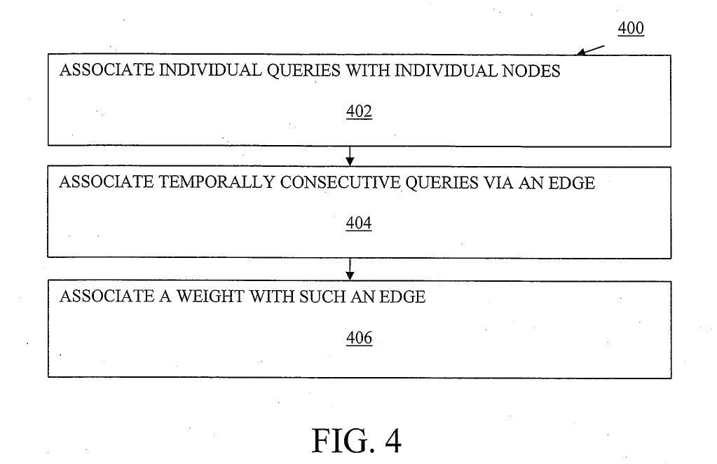

FIG. 4 is an illustrative flow diagram of a process 400 which may be utilized for forming of a query flow graph in accordance with some example embodiments. Additionally, although process 500, as shown in FIG. 4, comprises one particular order of actions, the order in which the actions are presented does not necessarily limit claimed subject matter to any particular order. Likewise, intervening actions not shown in FIG. 4 and/or additional actions not shown in FIG. 4 may be employed and/or some of the actions shown in FIG. 4 may be eliminated, without departing from the scope of claimed subject matter. Process 400 depicted in FIG. 4 may in alternative embodiments be implemented in software, hardware, and/or firmware, and may comprise discrete operations.

Such a determination of query dependencies, as discussed above with respect to process 300, may include operation of process 400 described below regarding forming of a query flow graph. At block 402, individual queries may be associated with individual nodes of a query flow graph. Such a query flow graph may be an outcome of query log mining and, at the same time, may be a useful tool for further query log analysis. As will be discussed in greater detail below, such a query flow graph may be formed based at least in part on mining time information related to a temporal order of queries, textual information related to a quantification of similarity between individual queries, as well as aggregating queries from different users. Using such an approach a query flow graph may be formed from a query log and utilized in segmenting interleaved query missions into separated query chains and/or formulating query recommendations. Additionally or alternatively, such a query flow graph may be utilized for other applications not limited to segmenting interleaved query missions into separated query chains and/or formulating query recommendations.

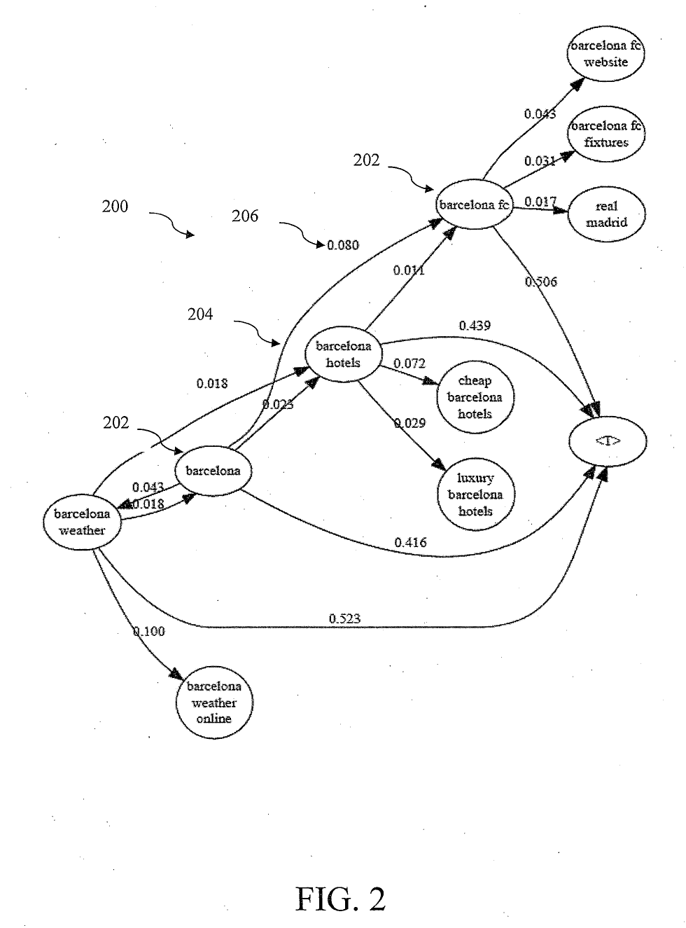

FIG. 2 is a diagram illustrating a query flow graph 200 in accordance with one or more exemplary embodiments. As illustrated, query flow graph 200 may include individual queries associated with individual nodes 202.

Referring back to FIG. 4, at block 404, temporally consecutive queries may be associated to one another via an edge. As used herein the term “edge” may refer to an association between query qᵢ to query qⱼ indicating that the two queries may be part of the same search mission. Any path over a query flow graph may proceed from an individual query associated with a corresponding node to another node, where those nodes are associated to one another via an edge.

Referring back to FIG. 2, as illustrated, query flow graph 200 may include an edge 204 associating individual nodes 202 to one another.

Referring back to FIG. 4, at block 406, a weight may be associated with such an edge. Such a weight may include a quantification of relatedness between temporally consecutive queries. For example, such weight may include a chain probability-type weight or a relative frequency-type weight, and/or the like, and/or combinations thereof. Any path over a query flow graph may proceed from an individual query associated with a corresponding node to another node, where those nodes are associated to one another via an edge. Such weights may be associated with such edges to represent a searching behavior, whose likelihood is given by the strength of such weight along such a path.

Referring back to FIG. 2, as illustrated, query flow graph 200 may include a weight 206 with such an edge 204. Given a query log, nodes 202 of query flow graph 200 may represent queries contained in the query log. Edges 204 between two queries qᵢ, qⱼ may have as a weight w(qᵢ, qⱼ). Such a weight may represent a probability that two queries qᵢ, qⱼ are part of the same search mission given that they appear in the same session. Additionally or alternatively, such a weight may represent a probability that query qⱼ follows query qᵢ. In both cases, when w(qᵢ, qⱼ) is high, qⱼ may be thought of as a typical reformulation of qᵢ, where such a reformulation is a step ahead towards a successful completion of a possible search mission.

Such a query flow graph G_{qf} may be defined as a directed graph G_{qf}=(V,E,w) where: a set of nodes may be V=Q∪{s, t}, where Q may represent a set of queries submitted to a search engine, s may represent a special node representing a starting state at a beginning a chain, and t may represent a special node representing a terminal state at an end of a chain; E⊂V×V may be the set of directed edges; w: E→(0 . . . 1] may be a weighting function that assigns to individual pair of queries, (q, q′)εE, a weight w(q, q′). In some cases, even if a query has been submitted multiple times to a search engine, possibly by many different users, it may be represented by a single node in a query flow graph. The two special nodes s and t may be used to capture the beginning and the end of query chains. In other words, the existence of an edge (s, qᵢ) may represent that qᵢ may be potentially a starting query in a chain, and an edge (qᵢ, t) may indicate that qᵢ may be a terminal query in a chain. Different applications may lead to different weighting schemes. Two such weighting schemes are described in greater detail below.

Procedure 400 may be utilized for building such a query flow graph G_{qf}=(V,E,w). Procedure 400 may take as input a set of sessions [symbol] ={S₁, . . . , Sₘ}. As discussed above, such a set of sessions may be constructed by sorting queries by user ID and by timestamp, and splitting them using a timeout threshold.

As stated in the previous section, the set of nodes V in a query flow graph is the set of distinct queries Q in query log [symbol] plus the two special nodes s and t. The connection of the two special nodes s and t to the other nodes of the query flow graph will not be discussed directly here, but is address in further detail below. Given two queries q, q′εQ, such queries may be tentatively connected with an edge in cases where there is at least one session in a set of sessions [symbol] in which q and q′ are consecutive. In other words, a set of tentative edges T may be formed based on the following equation:

T={(q,q′)|∃Sⱼε [symbol] ( [symbol] )s.t. q=qᵢεSⱼΛq′=qᵢ₊₁εSⱼ}.

One aspect of the construction of a query flow graph may be to define the weighting function w: E→(0 . . . 1]. Different applications may lead to different weighting schemes. Two such weighting schemes are described in greater detail here. A first weighting scheme may be based on a chaining probability, where such a chaining probability may represent a probability that q and q′ belong to the same chain (or search mission) given that they belong to the same session. A second weighting scheme may be based on relative frequencies of the pair (q, q′) and the query q.

Weights based on chaining probabilities may be determined using a machine learning method. In such a case, one step may be to extract for individual edges (q, q′)εT a set of features associated with an edge. Those features may be computed over several or all sessions in a set of sessions [symbol] that contain the queries q and q′ appearing consecutively in this order. Such features we may aggregate information about the time difference in which the queries are submitted, textual similarity of the queries, and/or the number of sessions in which the queries appear, and/or the like. Training data may be utilized to learning such a weighting function from such features. Such training data may be created by picking at random a set of edges (q, q′) (excluding the edges where q=s or q′=t) and manually assigning them a label, such as same_chain. This label, or target variable, may be assigned by human editors and may be set to a value of zero if q and q′ are not part of the same chain, and it may be set to a value of one if q and q′ are part of the same chain. A probability of having an edge included in a training set may be proportional to the number of times that queries forming a given edge occur consecutively in that order in a query log.

Such training data may be utilized to learn the function w(−,−), given the set of features and the label for each edge in T. In one example, such a set of features may include eighteen features to compute the function w(−,−) for each edge in T. In this example, given two consecutive queries (q,q′) the features may include one or more of the following features: a count of a number of sessions in which reformulation (q; q0) occurs; an average time elapsed between the queries in sessions in which both occur; a sum of reciprocal time (1/t) where t is the elapsed time between the two queries; a calculated similarity where both queries are turned into a bag of character tri-grams and the cosine similarity between the two bags is computed; a calculated similarity where both queries are turned into a bag of character tri-grams and the Jaccard similarity between the two bags is computed; a calculated similarity where both queries are turned into a bag of character tri-grams and the intersection between the two bags is computed; a calculated similarity where both queries are turned into a bag of stemmed terms and the cosine similarity between the two bags is computed; a calculated similarity where both queries are turned into a bag of stemmed terms and the Jaccard similarity between the two bags is computed; a calculated similarity where both queries are turned into a bag of stemmed terms and the intersection between the two bags is computed; an average number of clicks since session begin, among sessions containing this pair; an average number of clicks since the query preceding this pair, among all sessions containing this pair; an average session size expressed as number of queries, among sessions containing this pair; an average position in session expressed as number of queries before q since the session begun, among all sessions containing this pair; a ratio of a first feature of an average position in session expressed as number of queries before q since the session begun over a second feature of an average session size expressed as number of queries; a fraction of occurrences in which this pair of two consecutive queries (q,q′) is the first pair in the session; a fraction of occurrences in which this pair of two consecutive queries (q,q′) is the last pair in the session; a count of a number of sessions in which (q,q′) occurs divided by the number of sessions in which (q,x) occurs (for any x); and/or a count of a number of sessions in which (q,q′) occurs, divided by the number of sessions in which (x,q′) occurs (for any x); and/or the like; and/or combinations thereof. Several of these features may be effective for query segmentation. For example, textual features may be effective for query segmentation. For textual features, a textual similarity of queries q and q′ may be determined using various similarity measures, including cosine similarity, Jaccard coefficient, and/or a size of intersection. Such similarity measures may be determined on sets of stemmed words and/or on character-level 3-grams, and/or the like. In another example, session features may be effective for query segmentation. For session features, a number of sessions in which the pair (q, q′) appears may be determined. Additionally or alternatively, other statistics of such sessions in which the pair (q, q′) appears may be determined, such as, average session length, average number of clicks in the sessions, and/or average position of the queries in the sessions, and/or the like. In a still further example, time-related features may be effective for query segmentation. For time-related features, an average time difference between q and q′ in the sessions in which (q, q′) appears may be determined, and a sum of reciprocals of time difference over appearances of the pair (q, q′) may also be determined.

Another step for constructing the query flow graph may be to train a machine learning model to predict a label, such as the label same_chain described above. In such a case, a training dataset may include a number of already labeled examples. For example, such labels may be assigned by a person to facilitate such training.

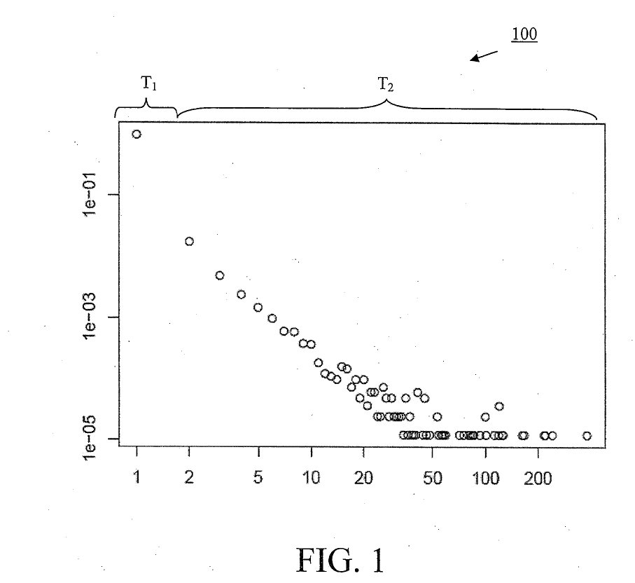

As shown in chart 100 of FIG. 1, a frequency of query pairs on a plotted against count of a number of times a given pair of query appears consecutively in that order. Such a frequency of query pairs may follow a power-law with a spike at count of one, where the count represents a number of times a given pair of query appears consecutively in that order. Based at least in part on such a plot of frequency versus count, data may be divided into two or more sub-sets. In one example, the classification problem may be divided into two sub-problems where the data may also be partitioned into two training subsets T₁ and T₂. For example, the data may also be partitioned into two training subsets T₁ and T₂ by distinguishing between pairs of queries appearing together only once which is illustrated at a count of one in FIG. 1 (this subset may be identified as T₁, which in this example may contain approximately 50% of the cases), and pairs of queries appearing together more than once which is illustrated above a count of one in FIG. 1 (this set may be identified as T₂).

The same or different models may be selected for training data subset T₁ and training data subset T₂ with respect to classification accuracy and/or simplicity of the model. In one example, T₁ may be analyzed with a logistic regression model using certain available features, such as, (a) a Jaccard coefficient between sets of stemmed words, (b) the number of n-grams in common between two queries, and (c) a time between two queries in seconds. T₂ may be analyzed with a rule based model including of several rules (e.g., eight rules, with four for each class), for example.

Such models and/or other like models may assign a weight w(q, q′) to one or more individual edges (q, q′). In particular, certain individual edges which have been classified as being in class one may be labeled as “same_chain”, based at least in part on a prediction by the model. Conversely, individual edges which have been classified in class zero may be labeled by a zero value. Here, for example, edges labeled by a zero value may be removed from or ignored in a query flow graph G_{qf}.

The edges starting from special node s or ending in special node t may be given an arbitrary weight. For example, edges starting from special node s or ending in special node t may be given an arbitrary weight w(s, q)=w(q, t)=1 for all q, or they may be left undefined.

As mentioned above, a second weighting scheme may be based on relative frequencies of the pair (q, q′) and the query q. Such a weighting based on relative frequencies may effectively turn a query flow graph into a Markov chain. For example, f(q) may be defined as the number of times query q appears in a query log, and f(q, q′) may be defined as the number of times query q′ follows immediately q in a session. Accordingly, f(s, q) and f(q, t) may indicate the number of times query q is the first and last query of a session, respectively. In such an embodiment, a weighting based on relative frequencies may be expressed as follows:

$${w}^{′} ( q , {q}^{′} ) = \{ \begin{matrix}\frac{f ( q , {q}^{′} )}{f ( q )} & if ( w ( q , {q}^{′} ) > θ ) ( q = s ) ( q = t ) \\ 0 & otherwise ,\end{matrix}$$

which uses chaining probabilities w(q, q′) to basically discard pairs that have a probability of less than μ to be part of the same chain. By construction, a sum of the weights of edges going out from individual node may be equal to 1. The result of such normalization can be viewed as the transition matrix P of a Markov chain.

Referring back to FIG. 2, a portion of an exemplary query flow graph 200 is illustrated using a weighting scheme based on relative frequencies, as described above. As illustrated in FIG. 2, a portion of a query flow graph containing the query “Barcelona” and some of its followers up to a depth of two, selected in decreasing order of count. Also, a terminal node t is present in FIG. 2. Here, for example, the sum of outgoing edges from each node does not reach one due to the partial nature of FIG. 2, as not all outgoing edges 204 (and relative destination nodes 202) are illustrated here.

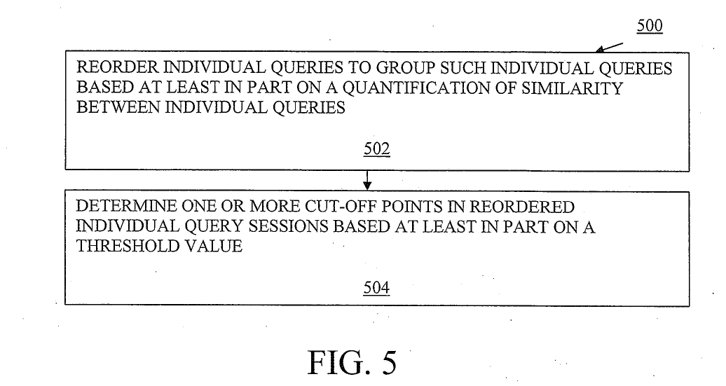

FIG. 5 is an illustrative flow diagram of a process 500 which may be utilized for segmentation of individual query sessions in accordance with some example embodiments. Additionally, although process 500, as shown in FIG. 5, comprises one particular order of actions, the order in which the actions are presented does not necessarily limit claimed subject matter to any particular order. Likewise, intervening actions not shown in FIG. 5 and/or additional actions not shown in FIG. 5 may be employed and/or some of the actions shown in FIG. 5 may be eliminated, without departing from the scope of claimed subject matter. Process 500 depicted in FIG. 5 may in alternative embodiments be implemented in software, hardware, and/or firmware, and may comprise discrete operations.

Such a segmentation of individual query sessions, as discussed above with respect to process 300, may include the operation of process 500 described below. As was presented above, finding chains may allow for improved query log analysis, user profiling, mining user behavior, and/or the like. For a given supersession S=<q₁, q₂, . . . , qₖ> of one particular user, a query flow graph may be computed with the sessions of S as part of its input. Alternatively, a query flow graph may be computed without the sessions of S as part of its input.

Process 500 may be separated into two portions: session reordering and session breaking. Session reordering may be utilized to ensure that queries belonging to the same search mission are consecutive. Session breaking may be facilitated after such session reordering, so that such session breaking may deal with non-interleaved chains.

Since chains, as defined herein, may not be consecutive in the supersession S, a supersession S may contain one or more chains having interleaved query missions. Process 500 may define a chain cover of S=<q₁, q₂, . . . qₖ> as a partition of the set {1, . . . , k} into subsets C₁, . . . , Cₕ; where individual sets

Cᵤ={i₁^{u}< . . . <iₗ_{ᵤ}^{u}}

may be thought of as a chain as follows:

$${C}_{u} = \{ {i}_{1}^{u} < … < {i}_{{l}_{u}}^{u} \}$$

Cᵤ=s,qᵢ_{₁}^{u}, . . . , qᵢₗᵤ,t,
that may be associated a probability as follows:

$$P = ( {C}_{u} ) = P ( s , {q}_{{i}_{1}^{u}} ) P ( {q}_{{i}_{1}^{u}} , {q}_{{i}_{2}^{u}} ) … P ( {q}_{{i}_{{l}_{u - 1}}^{u}} , {q}_{{i}_{{l}_{u }}^{u}} ) P ( {q}_{{i}_{{l}_{u}}^{u}} , t )$$

and a chain cover may be found that maximizes P(C₁) . . . P(Cₕ). In cases where a query appears more than once, “duplicate” nodes for that query may be added to the formulation, which may make the description of the process slightly more complicated than what is presented here. For simplicity, the details related to queries appearing more than once are omitted below since such are not fundamental to the understanding of process 500.

At block 502, individual queries associated with such individual query sessions may be reordered. Such an operation may be done in order to group such individual queries. Such a grouping may be based at least in part on such a quantification of similarity between individual queries, as discussed above at block 302.

In one example, such session reordering may be accomplished based at least in part on one or more greedy heuristics. For example, such session reordering may be analyzed as an instance of the Asymmetric Traveler Salesman Problem (ATSP). In such a case, w(q, q′) may be a weight defined as a chaining probability, as described above with respect to Process 400. Given a session S=<q₁, q₂, . . . qₖ>, a query flow graph Gₛ=(V,E, h) may be considered with nodes V={s, q₁, . . . , qₖ, f}, edges E, and edge weights h defined as h(qᵢ, qⱼ)=−log w(qᵢ, qⱼ). An edge (qᵢ, qⱼ) may exist in E if w(qᵢ, qⱼ)>0. One such reordering may be a permutation π of <1, 2, . . . k> that maximizes the following:

$${\prod }_{i = 1}^{k - 1} w ( {q}_{π ( i )} , {q}_{π ( i + 1 )} )$$

which may be equivalent to finding a Hamiltonian path of minimum weight in this graph. A greedy heuristic may be utilized to perform such session reordering. For example, such a greedy heuristic may select individual edges associated with minimum weight going out of a current node. Alternatively, an exact branch-and-bound solution may be determined, instead of using a greedy heuristic.

At block 504, one or more cut-off points in such reordered individual query sessions may be determined. Such a determination cut-off points in such reordered individual query sessions may also be referred to herein as session breaking. For example, such cut-off points may be determined based at least in part on a threshold value. Such a threshold value may include a given value at which a cut happens. For instance, if we have a transition from a first query session Q to a second query session Q′ with a value 0.3 and the threshold value has been set to 0.4, the transition may be cut. In one example, such a threshold value may be an input parameter that may be set by an analyst who is using the present procedure.

Such session breaking may be facilitated after session reordering, so that such session breaking may deal with non-interleaved chains. In one example, such session breaking may be accomplished by determining a threshold value η in a validation dataset, and then deciding to break a reordered session whenever

w(q_{π(i)},q_{π(i+1)})<η

Such a threshold value may be associated with an entire session. Alternatively, two or more threshold values may be utilized, such as by associating a different threshold value to different parts of a session. In such a case, local minima may be found in chaining probabilities along a reordered session.

In operation, a query flow graph, as described above with respect to FIGS. 2 and 4 may be utilized to formulate one or more query recommendations. Such a query recommendation may be sent to a user based at least in part on at least one separated query chain. In one example, such a query recommendation may be based at least in part on a maximum weight-type score associated with individual queries. For example, a query flow graph may be utilized pick, for an input query q, the node having a largest weight-type score w′(q, q′).

In another example, such a query recommendation may be based at least in part on a random walk-type score associated with individual queries. For example, when a user submits a query q to the engine, such a query recommendation may be based at least in part on a measure of relative importance of a relatively important query q′ with respect to a submitted query q. Such a random walk-type score may be based at least in part on a random walk with a restart to a single node in a query flow graph where a random surfer may start at an initial query q; then, at each step, with probability α<1 a surfer may follows one of the edges from the current node chosen proportionally to the weights associate with such edges, or with probability 1−α a surfer may instead jumps back to q.

In a still further example, such a query recommendation may be based at least in part on a query history associated with the user. For example, such a query recommendation may be based not only on the last query input by a user, but may additionally or alternatively be based on some of the previous queries in a user's history.

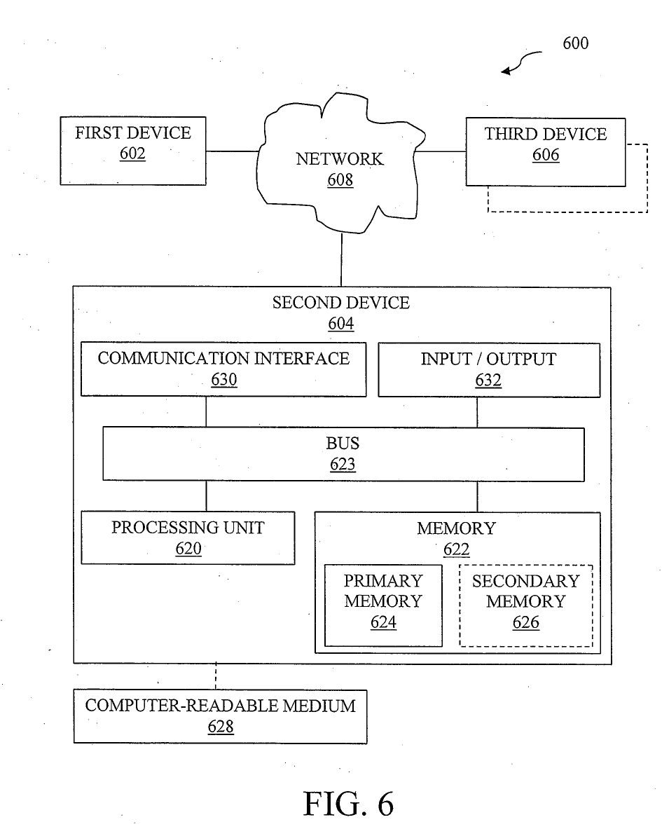

FIG. 6 is a block diagram illustrating an exemplary embodiment of a computing environment system 600 that may include one or more devices configurable to develop a hierarchical taxonomy and/or the like based at least in part on a cross-lingual query classification using one or more exemplary techniques illustrated above. For example, computing environment system 600 may be operatively enabled to perform all or a portion of process 300 of FIG. 3, process 400 of FIG. 4, and/or process 500 of FIG. 5.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like. A user may, for example, input a query and/or the like via first device 602.

In the context of this particular patent application, the term “special purpose computing platform” means or refers to a general purpose computing platform once it is programmed to perform particular functions pursuant to instructions from program software. By way of example, but not limitation, any of first device 602, second device 604, or third device 606 may include: one or more special purpose computing platforms once programmed to perform particular functions pursuant to instructions from program software. Such program software does not refer to software that may be written to perform process 300 of FIG. 3, process 400 of FIG. 4, and/or process 500 of FIG. 5. Instead, such program software may refer to software that may be executing in addition to and/or in conjunction with all or a portion of process 300 of FIG. 3, process 400 of FIG. 4, and/or process 500 of FIG. 5.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing process or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
determining at least one query dependency via a computing platform based at least in part on a temporal order of queries and a quantification of similarity between queries; and
segmenting at least one query session comprising two or more interleaved query missions into a plurality of query chains via said computing platform, based at least in part on said at least one query dependency.

2. The method of claim 1, wherein said segmenting at least one query session is performed without a timeout limit on said at least one query session.

3. The method of claim 1, wherein said segmenting at least one query session comprises:
reordering queries associated with said at least one query session to group said queries based at least in part on said quantification of similarity between queries; and
determining one or more cut-off points in said reordered at least one query session based at least in part on a threshold value.

4. The method of claim 1, wherein said segmenting at least one query session comprises:
reordering queries associated with said at least one query session to group said queries based at least in part on said quantification of similarity between queries;
determining one or more cut-off points in said reordered at least one query session based at least in part on a threshold value; and
wherein said segmenting at least one query session is performed without a timeout limit on said at least one query session.

5. The method of claim 1, wherein said determining at least one query dependency comprises forming a query flow graph comprising the following operations:
associating queries with individual nodes;
associating temporally consecutive queries via an edge; and
associating a weight with said edge, wherein said weight comprises a quantification of relatedness between temporally consecutive queries.

6. The method of claim 1, wherein said determining at least one query dependency comprises forming a query flow graph comprising the following operations:
associating queries with individual nodes;
associating temporally consecutive queries via an edge; and
associating a weight with said edge, wherein said weight comprises a quantification of relatedness between temporally consecutive queries, wherein said weight comprises a chain probability-type weight or a relative frequency-type weight.

7. The method of claim 1, further comprising sending a query recommendation to a user based at least in part on at least one of said plurality of query chains.

8. The method of claim 1, further comprising sending a query recommendation to a user based at least in part on at least one of said plurality of query chains, wherein said query recommendation is based at least in part on: a maximum weight-type score associated with queries in at least one of said plurality of query chains, a random walk-type score associated with queries in at least one of said plurality of query chains, and/or a query history associated with said user.

9. The method of claim 1, further comprising:
sending a query recommendation to a user based at least in part on at least one of said plurality of query chains, wherein said query recommendation is based at least in part on: a maximum weight-type score associated with queries in at least one of said plurality of query chains, a random walk-type score associated with queries in at least one of said plurality of query chains, and/or a query history associated with said user;
wherein said segmenting at least one query session comprises: reordering queries associated with said at least one query session to group said queries based at least in part on said quantification of similarity between queries, determining one or more cut-off points in said reordered at least one query session based at least in part on a threshold value, and wherein said segmenting at least one query session is performed without a timeout limit on said at least one query session; and
wherein said determining at least one query dependency comprises forming a query flow graph comprising the following operations: associating queries with individual nodes, associating temporally consecutive queries via an edge, and associating a weight with said edge, wherein said weight comprises a quantification of relatedness between temporally consecutive queries, wherein said weight comprises a chain probability-type weight or a relative frequency-type weight.

10. An article comprising:
a storage medium comprising machine-readable instructions stored thereon, which, if executed by one or more processing units, operatively enable a computing platform to:
determine at least one query dependency based at least in part on a temporal order of queries and a quantification of similarity between queries; and
segment at least one query session comprising two or more interleaved query missions into a plurality of query chains, based at least in part on said at least one query dependency.

11. The article of claim 10, wherein said segmentation of at least one query session is performed without a timeout limit on said at least one query session.

12. The article of claim 10, wherein said segmentation of at least one query session comprises:
reorder queries associated with said at least one query session to group said queries based at least in part on said quantification of similarity between queries; and
determine one or more cut-off points in said reordered at least one query session based at least in part on a threshold value.

13. The article of claim 10, wherein said determination of at least one query dependency comprises formation of a query flow graph comprising the following:
associate queries with individual nodes;
associate temporally consecutive queries via an edge; and
associate a weight with said edge, wherein said weight comprises a quantification of relatedness between temporally consecutive queries.

14. The article of claim 10, wherein said machine-readable instructions, if executed by the one or more processing units, operatively enable the computing platform to send a query recommendation to a user based at least in part on at least one of said plurality of query chains.

15. An apparatus comprising:
a computing platform, said computing platform being operatively enabled to:
determine at least one query dependency based at least in part on a temporal order of queries and a quantification of similarity between queries; and
segment at least one query session comprising two or more interleaved query missions into a plurality of query chains, based at least in part on said at least one query dependency.

16. The apparatus of claim 15, wherein said segmentation of at least one query session is performed without a timeout limit on said at least one query session.

17. The apparatus of claim 15, wherein said segmentation of at least one query session comprises:
reorder queries associated with said at least one query session to group said queries based at least in part on said quantification of similarity between queries;
determine one or more cut-off points in said reordered at least one query session based at least in part on a threshold value; and
wherein said segmentation of at least one query session is performed without a timeout limit on said at least one query session.

18. The apparatus of claim 15, wherein said determination of at least one query dependency comprises formation of a query flow graph comprising the following operations:
associate queries with individual nodes;
associate temporally consecutive queries via an edge; and
associate a weight with said edge, wherein said weight comprises a quantification of relatedness between temporally consecutive queries, wherein said weight comprises a chain probability-type weight or a relative frequency-type weight.

19. The apparatus of claim 15, wherein said computing platform being further operatively enabled to:
send a query recommendation to a user based at least in part on at least one of said plurality of query chains, wherein said query recommendation is based at least in part on: a maximum weight-type score associated with queries in at least one of said plurality of query chains, a random walk-type score associated with queries in at least one of said plurality of query chains, and/or a query history associated with said user.

20. The apparatus of claim 15, wherein said computing platform being further operatively enabled to:
send a query recommendation to a user based at least in part on at least one of said plurality of query chains, wherein said query recommendation is based at least in part on: a maximum weight-type score associated with queries in at least one of said plurality of query chains, a random walk-type score associated with queries in at least one of said plurality of query chains, and/or a query history associated with said user;
wherein said segmentation of at least one query session comprises: reorder of queries associated with said at least one query session to group said queries based at least in part on said quantification of similarity between queries, determination of one or more cut-off points in said reordered at least one query session based at least in part on a threshold value, and wherein said segmentation of at least one query session is performed without a timeout limit on said at least one query session; and
wherein said determination of at least one query dependency comprises formation of a query flow graph comprising the following operations: associate queries with individual nodes, associate temporally consecutive queries via an edge, and associate a weight with said edge, wherein said weight comprises a quantification of relatedness between temporally consecutive queries, wherein said weight comprises a chain probability-type weight or a relative frequency-type weight.
